(19) United States
(12) Patent Application Publication
(10) Pub. No.: US 2012/0251758 A1
(43) Pub. Date: Oct. 4, 2012

(54) HEAT INSULATION MATERIAL

(76) Inventors: Takashi Hashimoto, Tokyo (JP); Yoshikazu Hasegawa, Tokyo (JP)

(21) Appl. No.: 13/514,890

(22) PCT Filed: Dec. 14, 2010
(86) PCT No.: PCT/JP2010/072445

§ 371 Date: Jun. 8, 2012

(30) Foreign Application Priority Data
Dec. 24, 2009 (JP) 2009-292066

(51) Int. Cl. E04B 1/80; B32B 3/02; B32B 5/32

(52) U.S. Cl. 428/44; 428/105; 428/60; 428/54; 428/77

(57) ABSTRACT

A heat insulation material which is formed of a laminated body in which a plurality of plate-like bodies are stacked, can exhibit a heat insulation property, and is sufficiently eco-friendly. In each of the plate-like bodies, a plurality of rod-like foams, obtained by extrusion-foaming a foam material, are oriented in one direction to be fanned integrally with each other, and the plate-like bodies neighboring in the lamination direction are stacked so that an orientation direction of the foams of one plate-like body and an orientation direction of the foams of the other plate-like body are nearly perpendicular to each other.

### TECHNICAL FIELD

The present invention relates to a heat insulation material which is constructed under the floor and on the ceiling, wall, roof, and the like of a building.

Priority is claimed on Japanese Patent Application No. 2009-292066, filed Dec. 24, 2009, the content of which is incorporated herein by reference.

### BACKGROUND ART

Generally, a heat insulating material is constructed under the floor and on the ceiling, wall, roof, and the like of a building such as a house. For example, when a heat insulation material is constructed under the floor, the heat insulation material is disposed between lumber girders, joists, or the like, and a plywood base or the like is installed on the heat insulation material.

As a heat insulation material, for example, a heat insulation material (see PTLs 1 and 2) obtained by extrusion-foaming a foam material including polypropylene, used paper, and starch, a heat insulation material (see PTL 3) using a foamed synthetic resin such as styrofoam, and a foamed resin-based heat insulation material (see PTL 4) such as a polystyrene resin and a polyurethane resin have become known.

The heat insulation material described in PTL 1 is manufactured by integrally forming a plurality of foams, foamed with the extrusion of a foam material from a plurality of small holes, into a plate shape. The method of manufacturing a heat insulation material by integrally forming a plurality of foams into a plate shape is also proposed in other technical documents (see PTLs 5 to 7).

The heat insulation materials described in PTLs 2 to 4 are manufactured by extrusion-forming a foam material into a plate shape.

### CITATION LIST

### Patent Literature

[PTL 1] Japanese Patent No. 4069255

[PTL 2] JP-A-2003-41041

[PTL 3] JP-A-2006-291461

[PTL 4] JP-A-2008-196270

[PTL 5] Japanese Patent No. 3393341

[PTL 6] JP-T-2004-500998

[PTL 7] JP-A-2007-204590

### SUMMARY OF INVENTION

### Technical Problem

However, since the heat insulation materials described in PTLs 1 and 2 include large amounts of used paper and starch, these are eco-friendly, but have low rigidity. Therefore, when being disposed in a frame body such as a lumber girder, the heat insulation material is bent due to its own weight and sags at the center, and thus a gap may be formed between a plywood base installed on the heat insulation material and the heat insulation material, and the heat insulation property may be reduced.

The heat insulation materials described in PTLs 3 and 4 are not necessarily sufficient in environment-friendliness. Furthermore, a heat insulation material using a polystyrene resin tends to have an insufficient heat insulation property. In order to improve the heat insulation property, it is preferable that the heat insulation material have a large thickness. However, when the heat insulation material has a large thickness, the size of a frame body in which the heat insulation material is disposed also varies in accordance with the thickness of the heat insulation material, and thus it is necessary to secure a space to accept the heat insulation material therein and the cost increases.

In addition, the heat insulation materials obtained by integrally forming a plurality of foams into a plate shape as described in PTLs 1 and 5 to 7 and the heat insulation materials obtained by extrusion-forming a foam material into a plate shape as described in PTLs 2 to 4 are not sufficient in rigidity. Therefore, when being disposed in a frame body, the heat insulation material is bent due to its own weight and sags at the center, and thus a gap is formed and the heat insulation property is reduced.

The invention is contrived in view of such problems of the conventional techniques, and an object of the invention is to provide a heat insulation material which can exhibit an excellent heat insulation property and is sufficiently eco-friendly.

### Solution to Problem

A heat insulation material of the invention is a heat insulation material including: a laminated body in which a plurality of plate-like bodies are stacked, in which in each of the plate-like bodies, a plurality of rod-like foams, obtained by extrusion-foaming a foam material, are oriented in one direction to be formed integrally with each other, and the plate-like bodies neighboring in the lamination direction are stacked so that an orientation direction of the foams of one plate-like body and an orientation direction of the foams of the other plate-like body are nearly perpendicular to each other.

Here, the heat insulation material of the invention may be disposed in a frame body.

In addition, from among side surfaces of the laminated body, side surfaces which are brought into contact with the frame body may be inclined.

Furthermore, the side surfaces which are brought into contact with the frame body may be inclined inward from an upper surface or a bottom surface of the laminated body toward the bottom surface or the upper surface opposed thereto, and at least one of the side surfaces which are brought into contact with the frame body may be a surface perpendicular to the orientation direction of the foams of the plate-like body including one of the upper surface and the bottom surface of the laminated body wider than the other. In the plate-like body including the wider surface, near side surfaces at both ends of the foams of the plate-like body, a groove perpendicular to the orientation direction of the foams may be formed along the side surfaces at both ends.

In addition, when the frame body is formed of frame members extending parallel to each other, from among the side surfaces of the laminated body, a side surface which is not brought into contact with the frame body and a side surface on the opposite side may be inclined in the same direction.

Furthermore, when the frame body is formed of frame members extending parallel to each other, any of the plate-like bodies neighboring in the lamination direction may deviate in a direction in which a side surface which is not brought into contact with the frame body is connected to a side surface on the opposite side.

In addition, when the frame body has a grid shape, in the plate-like bodies, a side surface parallel to the orientation direction of the foams may be inclined.

Furthermore, a moisture-permeable reinforcing sheet may be adhered to a bottom surface of the laminated body so that the reinforcing sheet extends to be longer than the thickness of the heat insulation material in a direction parallel to the orientation direction of the foams of the plate-like body including a upper surface opposed to the bottom surface.

In addition, the foam material preferably may include a polyolefin resin, cellulose, and starch.

### Advantageous Effects of Invention

According to the invention, it is possible to provide a heat insulation material which can exhibit an excellent heat insulation property and is sufficiently eco-friendly.

### BRIEF DESCRIPTION OF DRAWINGS

FIG. 1 is a perspective view showing an example of a state in which a heat insulation material of the invention is disposed in a frame body.

FIG. 2 is a perspective view showing an example of the heat insulation material of the invention.

FIG. 3A is a side view when the heat insulation material shown in FIG. 2 is viewed from A.

FIG. 3B is a side view when the heat insulation material shown in FIG. 2 is viewed from B.

FIG. 4A is an enlarged view of the circle X of FIG. 3A showing a state before the deformation of first and second movable pieces.

FIG. 4B is an enlarged view of the circle X of FIG. 3A showing a state after the deformation of the first and second movable pieces.

FIG. 5A is a cross-sectional view showing the relationship between the frame body and the heat insulation material when the heat insulation material shown in FIG. 2 is viewed from A, and showing a state before the heat insulation material is disposed in the frame body.

FIG. 5B is a cross-sectional view showing the relationship between the frame body and the heat insulation material when the heat insulation material shown in FIG. 2 is viewed from A, and showing a state after the heat insulation material is disposed in the frame body.

FIG. 6 is a cross-sectional view showing a state in which the heat insulation material shown in FIG. 2, when viewed from B, is disposed in the frame body.

FIG. 7A is a process diagram illustrating an example of a heat insulation material manufacturing method, and showing a process of stacking plate-like bodies.

FIG. 7B is a process diagram illustrating an example of the heat insulation material manufacturing method, and showing a process of cutting a contact side surface of the laminated body.

FIG. 7C is a process diagram illustrating an example of the heat insulation material manufacturing method, and showing a process of cutting a non-contact side surface of the laminated body.

FIG. 7D is a process diagram illustrating an example of the heat insulation material manufacturing method, and showing a process of adhering a reinforcing sheet to a bottom surface of the laminated body.

FIG. 8A is a side view showing another example of the heat insulation material when the heat insulation material shown in FIG. 2 is viewed from B.

FIG. 8B is a cross-sectional view showing a state in which the heat insulation material shown in FIG. 8A is disposed in the frame body.

FIG. 9 is a perspective view showing another example of the frame body.

FIG. 10A is a perspective view of another example of the heat insulation material.

FIG. 10B is a side view when the heat insulation material shown in FIG. 10A is viewed from C.

FIG. 10C is a side view when the heat insulation material shown in FIG. 10A is viewed from D.

FIG. 11A is a cross-sectional view showing a state in which the heat insulation material shown in FIG. 10A, viewed from C, is disposed in the frame body.

FIG. 11B is a cross-sectional view showing a state in which the heat insulation material shown in FIG. 10A, viewed from D, is disposed in the frame body.

FIG. 12A is a perspective view of another example of the heat insulation material.

FIG. 12B is a side view when the heat insulation material shown in FIG. 12A is viewed from E.

FIG. 12C is a side view when the heat insulation material shown in FIG. 12A is viewed from F.

FIG. 13A is a cross-sectional view showing a state in which the heat insulation material shown in FIG. 12A, viewed from E, is disposed in the frame body.

FIG. 13B is a cross-sectional view showing a state in which the heat insulation material shown in FIG. 12A, viewed from F, is disposed in the frame body.

FIG. 14 is a perspective view showing another example of the frame body.

FIG. 15A is a perspective view of another example of the heat insulation material.

FIG. 15B is a side view when the heat insulation material shown in FIG. 15A is viewed from G.

FIG. 15C is a side view when the heat insulation material shown in FIG. 15A is viewed from H.

FIG. 16A is a cross-sectional view showing a state in which the heat insulation material shown in FIG. 15A, when viewed from G, is disposed in the frame body.

FIG. 16B is a cross-sectional view showing a state in which the heat insulation material shown in FIG. 15A, when viewed from H, is disposed in the frame body.

FIG. 17A is a diagram schematically showing orientation directions of the foams of the plate-like bodies of a heat insulation material manufactured by the process of Example 1.

FIG. 17B is a diagram schematically showing orientation directions of the foams of the plate-like bodies of a heat insulation material manufactured by the process of Example 2.

FIG. 17C is a diagram schematically showing orientation directions of the foams of the plate-like bodies of a heat insulation material manufactured by the process of Example 3.

FIG. 17D is a diagram schematically showing orientation directions of the foams of the plate-like bodies of a heat insulation material manufactured by the process of Example 4.

FIG. 17E is a diagram schematically showing orientation directions of the foams of the plate-like bodies of a heat insulation material manufactured by the process of Comparative Example 1.

FIG. 18A is a diagram illustrating a method of measuring a bending amount evaluated in the examples and comparative example, and schematically showing a state in which the heat insulation material is put on supporting members.

FIG. 18B is a diagram illustrating the method of measuring a bending amount evaluated in the examples and comparative example, and schematically showing a state in which the heat insulation material put on the supporting members is bent.

### DESCRIPTION OF EMBODIMENTS

Hereinafter, the invention will be described with reference to the drawings.

### First Embodiment

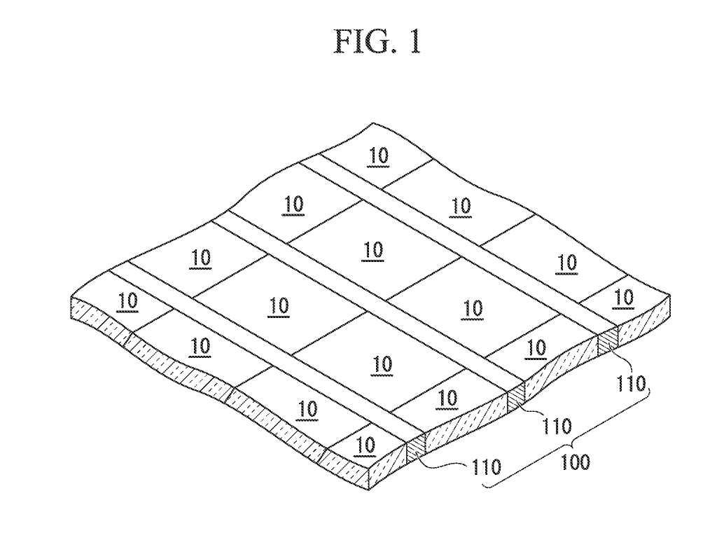

FIG. 1 is a perspective view showing an example of a floor structure in which a heat insulation material of the invention is disposed in a frame body. Heat insulation materials 10 are disposed in a frame body 100 formed of frame members (cross members supporting a floorboard and a joist: lumber girder) 110 extending parallel to each other.

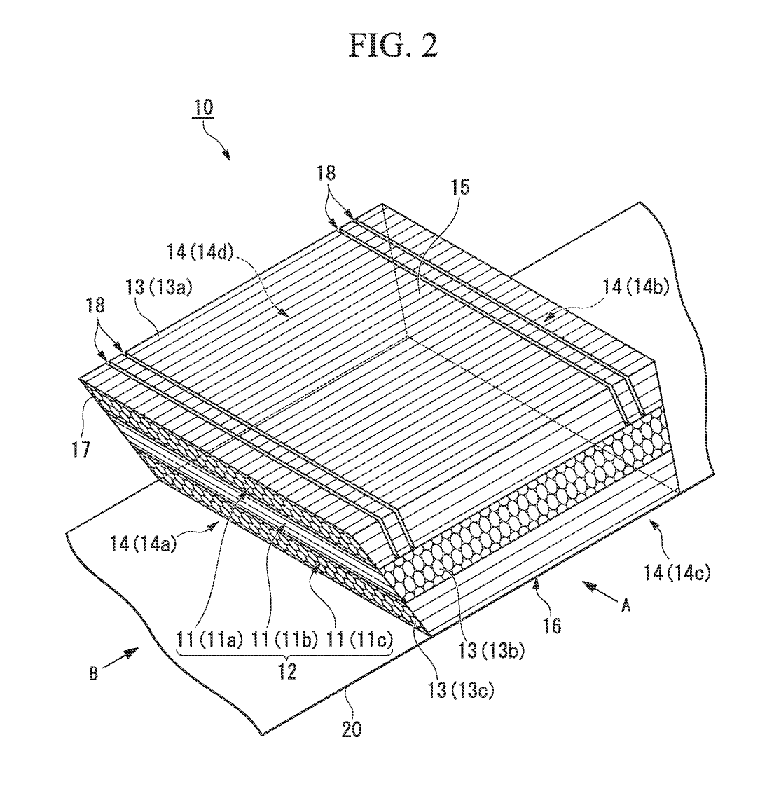

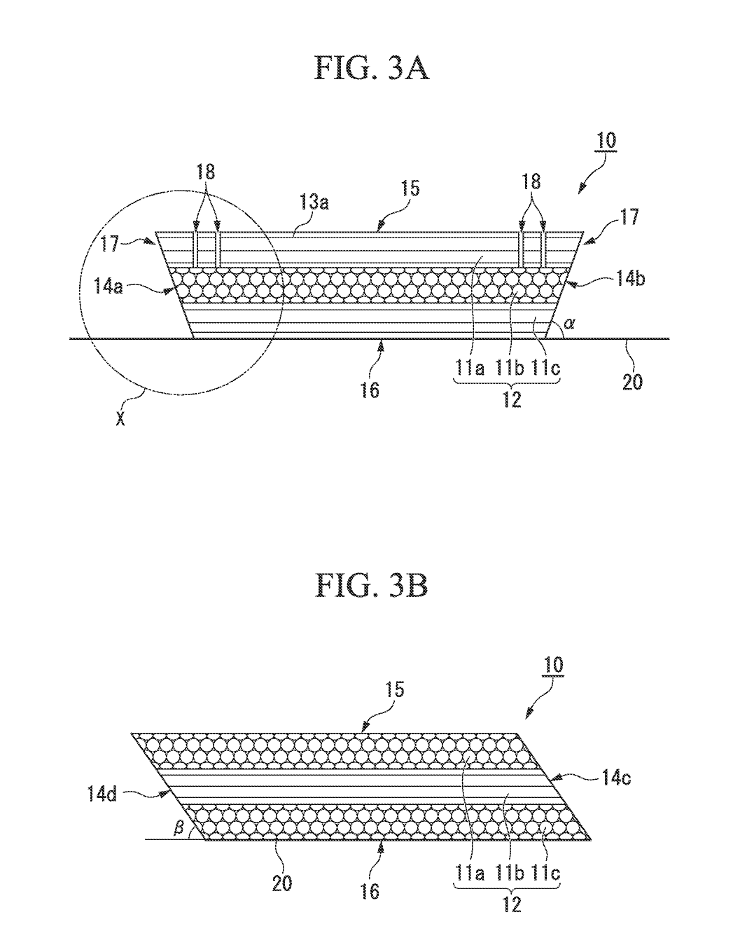

FIG. 2 is a perspective view showing an example of the heat insulation material that is disposed in the frame body 100 shown in FIG. 1, and FIGS. 3A and 3B are side views of the heat insulation material shown in FIG. 2.

In the invention, the same constituent elements as in FIG. 2 will be denoted by the same symbols in the following FIGS. 3A to 17E, and descriptions thereof will be omitted. In addition, in FIGS. 1 to 18B, the dimensional ratios and the like are different from actual ones for the sake of convenience of description.

The heat insulation material 10 shown in FIG. 2 is formed of a laminated body 12 in which three plate-like bodies 11 are stacked. In the invention, the three plate-like bodies 11 of the laminated body 12 in this example are set as a first plate-like body 11a, a second plate-like body 11b, and a third plate-like body 11c in order from top to bottom.

In each of the plate-like bodies 11, a plurality of rod-like foams 13 obtained by extrusion-foaming a foam material are oriented in one direction and integrally formed into a plate shape. As the foam material, a material including a polyolefin resin, cellulose, and starch is preferably used.

Examples of the polyolefin resin include a polyethylene resin and a polypropylene resin.

As the cellulose, used paper such as newspapers and magazines can be used as a raw material. The used paper is used after being pulverized into a predetermined size by a pulverizer.

As the starch, corn starch, wheat starch, rice starch, and the like can be used.

Regarding the ratios of the respective components in 100 mass % of the foam material, the polyolefin resin is preferably in the range of 30 to 50 mass %, the cellulose is preferably in the range of 10 to 40 mass %, and the starch is preferably in the range of 20 to 40 mass %.

In addition, the foam material may contain various kinds of additives such as an antioxidant, a fungicide, and a pigment, which are used in the heat insulation material, if necessary.

Since the heat insulation material 10 of the invention is formed of the plate-like bodies 11 including cellulose (used paper) and starch, it is sufficiently eco-friendly.

The plate-like body 11 can be formed, for example, as follows.

First, the above-mentioned material is extruded and foamed from a die having a plurality of pores, and a plurality of rod-like foams 13 according to the number of the pores are oriented in one direction, and brought into close contact with each other with no gap therebetween to be formed integrally with each other, whereby the resulting assembly is obtained. In the foaming, water is preferably used as a foaming agent.

The assembly is formed into a plate shape to obtain the plate-like body 11.

The thickness of the plate-like body 11 is preferably in the range of 5 to 50 mm, more preferably in the range of 20 to 50 mm, and most preferably in the range of 20 to 40 mm.

In the laminated body 12, the plate-like bodies 11 neighboring in the lamination direction are stacked so that an orientation direction of the foams of one plate-like body is nearly perpendicular to an orientation direction of the foams of the other plate-like body.

That is, in the laminated body 12 shown in FIG. 2, an orientation direction of foams 13a of the first plate-like body 11a is nearly perpendicular to an orientation direction of foams 13b of the second plate-like body 11b, and the orientation direction of the foams 13b of the second plate-like body 11b is nearly perpendicular to an orientation direction of foams 13c of the third plate-like body 11c. In addition, the orientation direction of the foams 13a of the first plate-like body 11a is the same as the orientation direction of the foams 13c of the third plate-like body 11c.

In the invention, “nearly perpendicular to” means within the range of 90° ±10°.

The plate-like body 11 is excellent in rigidity with respect to a direction parallel to the orientation direction of the foams 13, but is low in rigidity with respect to a direction perpendicular to the orientation direction. When an external force is applied to the plate-like body in the direction perpendicular to the orientation direction, the plate-like body is elastically deformed and easily bent.

However, as mentioned above, when the neighboring plate-like bodies 11 are stacked so that an orientation direction of the foams of one plate-like body is nearly perpendicular to an orientation direction of the foams of the other plate-like body, the heat insulation material 10 can exhibit excellent rigidity with respect to any direction.

That is, the respective plate-like bodies 11 can exhibit excellent rigidity with respect to a direction parallel to the orientation direction of the foams 13, whereby when the respective plate-like bodies 11 are stacked so that the orientation directions of the foams 13 are nearly perpendicular to each other, the directions in which the respective plate-like bodies exhibit rigidity are nearly perpendicular to each other. Accordingly, for example, even when an external force is applied to the heat insulation material 10 in a direction parallel to the orientation direction of the foams 13a of the first plate-like body 11a, the heat insulation material 10 is not easily bent due to the rigidity of the first plate-like body 11a and the third plate-like body 11c. In addition, even when an external force is applied to the heat insulation material 10 in a direction perpendicular to the orientation direction of the foams 13a of the first plate-like body 11a, the heat insulation material 10 is not easily bent due to the rigidity of the second plate-like body 11b.

Accordingly, since the heat insulation material 10 of the invention is excellent in rigidity even when an external force is applied thereto in any direction, it is not easily bent. Therefore, the bending and sagging at the center of the heat insulation material when it is disposed in the frame body are reduced, the gap is not easily formed between the plywood base installed on the heat insulation material and the heat insulation material, and an excellent heat insulation property can be exhibited.

Here, in the heat insulation material 10 shown in FIGS. 1 and 2, from among side surfaces 14 of the laminated body 12, side surfaces 14a and 14b perpendicular to the orientation direction of the foams 13a of the first plate-like body 11a including an upper surface 15 of the laminated body 12 are set as side surfaces which come into contact with the frame body 110 (hereinafter, referred to as “contact side surfaces”), and side surfaces 14c and 14d parallel to the orientation direction of the foams 13a are set as side surfaces which do not come into contact with the frame body 110 (hereinafter, referred to as “non-contact side surfaces”).

In addition, FIG. 3A shows a side view of the heat insulation material when the heat insulation material 10 is viewed from A (viewed from the non-contact side surface 14c), and FIG. 3B shows a side view of the heat insulation material when the heat insulation material 10 is viewed from B (viewed from the contact side surface 14a).

In the heat insulation material 10 shown in FIG. 2, from among the side surfaces 14 of the laminated body 12, the contact side surfaces 14a and 14b are inclined inward from the upper surface 15 of the laminated body 12 toward a bottom surface 16 opposed to the upper surface 15 as shown in FIG. 3A. The non-contact side surfaces 14c and 14d are inclined in the same direction as shown in FIG. 3B.

The inclination degrees of the contact side surfaces 14a and 14b and the non-contact side surfaces 14c and 14d of the laminated body 12 cannot be clearly determined since these are appropriately set in accordance with the interval between the frame members of the frame body and the like. However, for example, an inclination angle α of the contact side surfaces 14a and 14b is preferably in the range of 5 to 12°, and an inclination angle β of the non-contact side surfaces 14c and 14d is preferably in the range of 5 to 12°.

The inclination angles α and β are more preferably in the range of 5 to 10°, and most preferably in the range of 6 to 8°.

Furthermore, in the heat insulation material 10, the upper surface 15 is wider than the bottom surface 16 as shown in FIG. 3A. In addition, in the first plate-like body 11a including the upper surface 15, near side surfaces 17 at both ends of the foams 13a from among the side surfaces of the first plate-like body 11a, two grooves 18 perpendicular to the orientation direction of the foams 13a are formed along the side surfaces 17 at both ends.

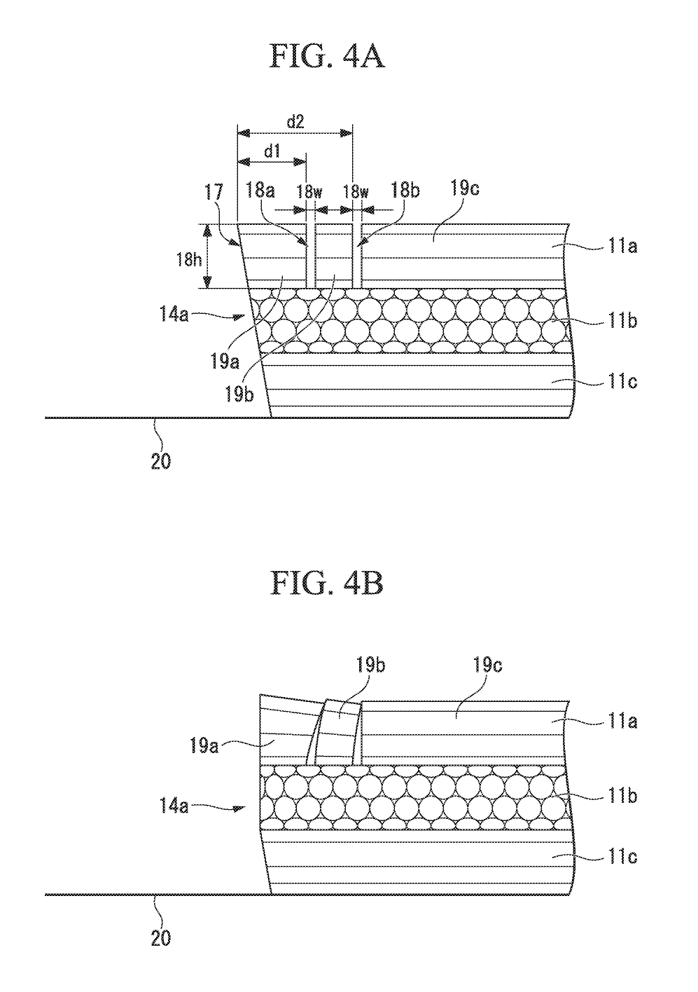

Specifically, as shown in FIG. 4A, in the first plate-like body 11a, a portion outside a first groove 18a is a first movable piece 19a, a portion surrounded by the first groove 18a and a second groove 18b is a second movable piece 19b, and a portion inside the second groove 18b is a non-movable portion 19c. When an external force is applied from the side surfaces 17 at both ends, the first movable piece 19a is deformed and brought into contact with the second movable piece 19b as shown in FIG. 4B. At the same time, the second movable piece 19b is pushed and deformed by the first movable piece 19a and brought into contact with the non-movable portion 19c.

Regarding the positions at which the grooves 18 are formed in the first plate-like body 11a, a distance dl from the first groove 18a to the side surface 17 is preferably in the range of 10 to 50 mm, and a distance d2 from the second groove 18b to the side surface 17 is preferably in the range of 40 to 100 mm. The distance d1 is more preferably in the range of 20 to 50 mm, and most preferably in the range of 25 to 40 mm, and the distance d2 is more preferably in the range of 45 to 80 mm, and most preferably in the range of 45 to 60 mm.

In addition, widths 18w of the first groove 18a and the second groove 18b are preferably in the range of 2 to 5 mm. The widths 18w of the first groove 18a and the second groove 18b may be the same as or different from each other.

Furthermore, depths 18h of the first groove 18a and the second groove 18b may be the same as or smaller than the thickness of the first plate-like body 11a. However, the depths 18h are preferably the same as the thickness of the first plate-like body 11a.

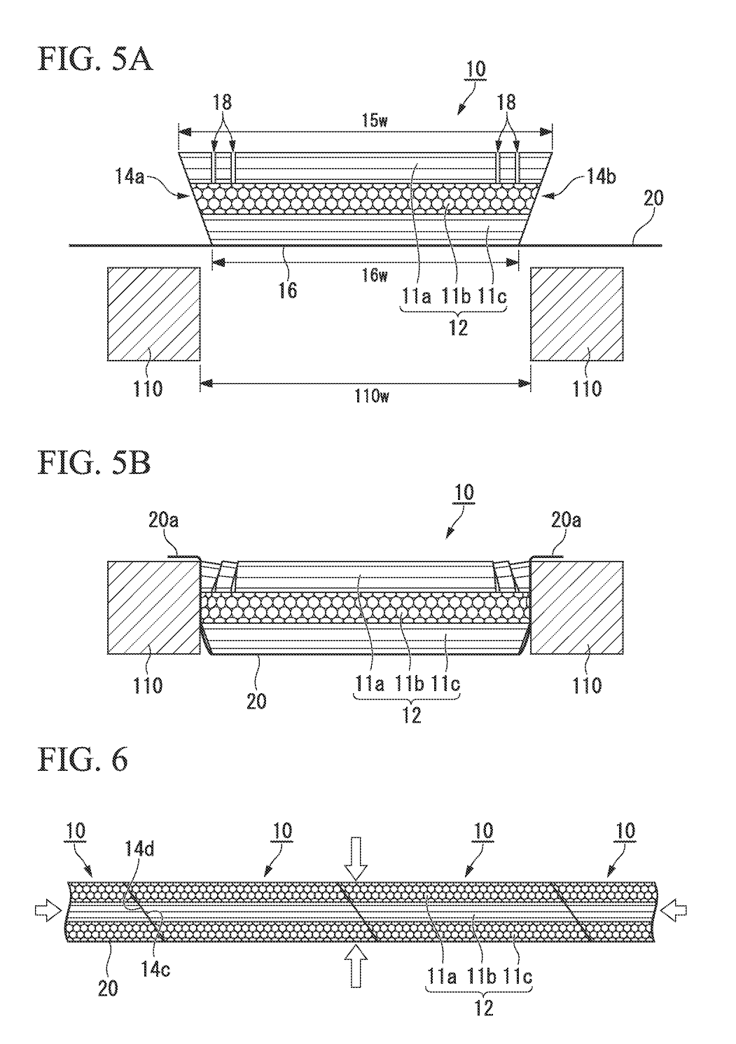

As shown in FIG. 5A, in the heat insulation material 10, a width (width when the heat insulation material 10 of FIG. 2 is viewed from A) 16w of the bottom surface 16 of the laminated body 12 is slightly smaller than a distance 110w between the frame members 110, and the contact side surfaces 14a and 14b are inclined inward from the upper surface 15 toward the bottom surface 16. In addition, a width (width when the heat insulation material 10 of FIG. 2 is viewed from A) 15w of the upper surface 15 of the laminated body 12 is larger than the distance 110w between the frame members 110, and a portion protruding between the frame members 110 is formed. However, the heat insulation material 10 has elasticity, whereby when the heat insulation material 10 is inserted between the frame members 110, the contact side surfaces 14a and 14b are pushed against the frame members 110 and the protruding portion is pushed between the frame members 110. Accordingly, as shown in FIG. 5B, the heat insulation material 10 is disposed between the frame members 110 with no gap therebetween.

In the second plate-like body 11b, from among the side surfaces thereof, side surfaces parallel to the orientation direction of the foams correspond to the contact side surfaces 14a and 14b. Since the plate-like body is low in rigidity with respect to a direction perpendicular to the orientation direction of the foams, that is, with respect to an external force from the side surfaces parallel to the orientation direction of the foams, the second plate-like body 11b is easily deformed elastically when an external force is applied thereto from the contact side surfaces 14a and 14b. Accordingly, when the contact side surfaces 14a and 14b are pushed when the heat insulation material 10 is inserted between the frame members 110, the second plate-like body 11b is elastically deformed, and thus the heat insulation material 10 is easily pushed between the frame members 110.

The side surfaces of the first plate-like body 11a perpendicular to the orientation direction of the foams correspond to the contact side surfaces 14a and 14b. Since the plate-like body is excellent in rigidity with respect to a direction parallel to the orientation direction of the foams, that is, with respect to an external force from the side surfaces perpendicular to the orientation direction of the foams, the first plate-like body 11a is not easily deformed elastically in comparison to the second plate-like body 11b even when an external force is applied from the contact side surfaces 14a and 14b.

However, in the first plate-like body, the grooves 18 are provided near the side surfaces (that is, side surfaces at both ends of the foams) perpendicular to the orientation direction of the foams as mentioned above. Since the grooves 18 are formed, the first movable piece 19a and the second movable piece 19b are deformed as shown in FIG. 4B when the heat insulation material 10 is pushed against the frame members 110, whereby the heat insulation material 10 is easily pushed between the frame members 110.

As in the case of the first plate-like body 11a, the third plate-like body 11c is not easily deformed elastically even when an external force is applied from the contact side surfaces 14a and 14b. However, since the third plate-like body 11c including the bottom surface 16 of the laminated body 12 hardly protrudes between the frame members 110, the third plate-like body 11c can be easily pushed between the frame members 110.

In addition, as shown in FIG. 3B, in the heat insulation material 10, the non-contact side surfaces 14c and 14d of the laminated body 12 are inclined in the same direction. Accordingly, as shown in FIG. 1, when heat insulation materials 10 are arranged in a line in the longitudinal direction of the frame member 110, the neighboring heat insulation materials support each other while pushing each other not only in the arrangement direction (horizontal direction) but also in the vertical direction (see FIG. 6), and thus the heat insulation materials 10 can be disposed with no gap therebetween.

Furthermore, in the heat insulation material 10, as shown in FIG. 2, a reinforcing sheet 20 is adhered to the bottom surface 16 of the laminated body 12.

The reinforcing sheet 20 extends in a direction parallel to the orientation direction of the foams 13a of the first plate-like body 11a so as to be longer than the thickness of the heat insulation material 10, and is adhered to the bottom surface 16 of the laminated body 12. As shown in FIG. 5B, when the heat insulation material 10 is disposed between the frame members 110, an extending portion 20a of the reinforcing sheet 20 is nailed and fixed to the frame member 110 by a tucker or the like. Accordingly, it is possible to effectively suppress the heat insulation material 10 from being detached between the frame members 110.

As the reinforcing sheet 20, non-woven fabric is preferably used. Specifically, non-woven fabric made of polyethylene terephthalate, polyethylene or the like is preferred.

In addition, the reinforcing sheet 20 preferably has a tensile strength of 10 N or greater. As described above, when the heat insulation material 10 is disposed between the frame members 110, the extending portion 20a of the reinforcing sheet 20 is nailed and fixed to the frame member 110. Therefore, the reinforcing sheet 20 is easily pulled, but when the tensile strength is 10 N or greater, the reinforcing sheet 20 is not easily broken even when being pulled.

The tensile strength of the reinforcing sheet 20 is measured using JIS L-1906.

Furthermore, the reinforcing sheet 20 preferably has moisture permeability. Since conventional heat insulation materials including cellulose and conventional plywood bases installed on the heat insulation materials have hygroscopicity, the heat insulation materials and the plywood bases are not easily dried in some cases when including indoor dampness or the like. Conventionally, in the construction by a 2×4 construction method, when a plywood base is exposed to rain during the construction, the rainwater retains between the plywood base and the heat insulation material in some cases.

In the invention, since the moisture-permeable reinforcing sheet 20 is adhered to the bottom surface 16 of the laminated body 12, the moisture in the heat insulation material and the plywood base can wick away and they are easily dried when the heat insulation material 10 and the plywood base absorbs the moisture. In addition, even when the plywood base is exposed to rain during the construction, the rainwater is not readily retained.

Next, an example of the method of manufacturing the heat insulation material 10 shown in FIG. 2 will be described.

First, three plate-like bodies 11 are prepared by the above-mentioned method.

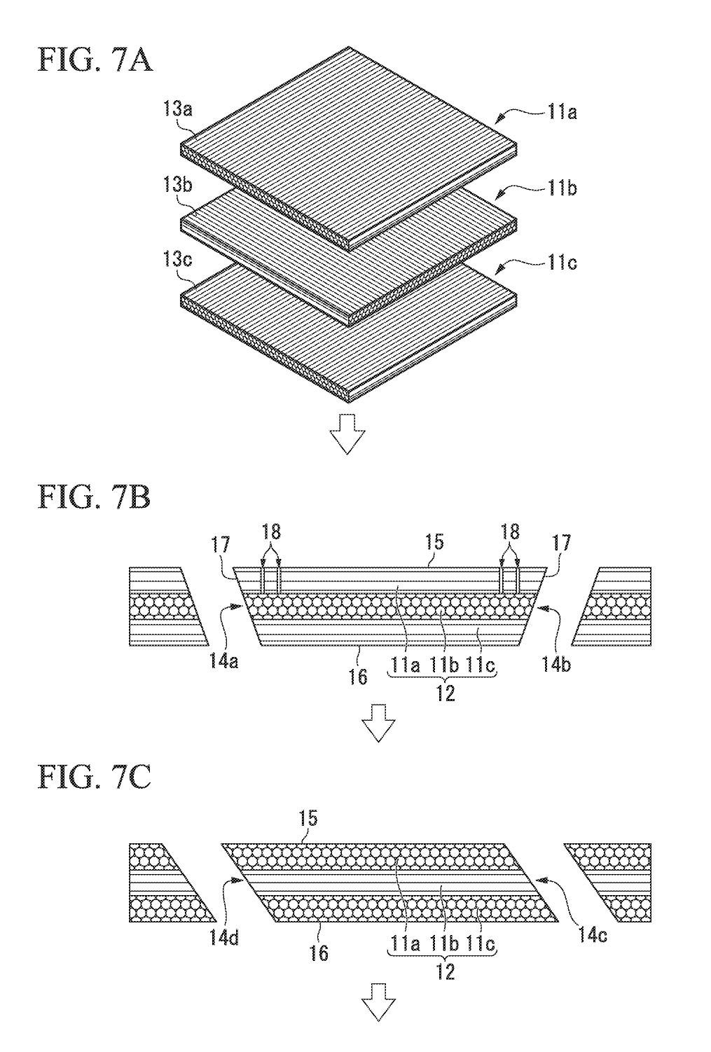

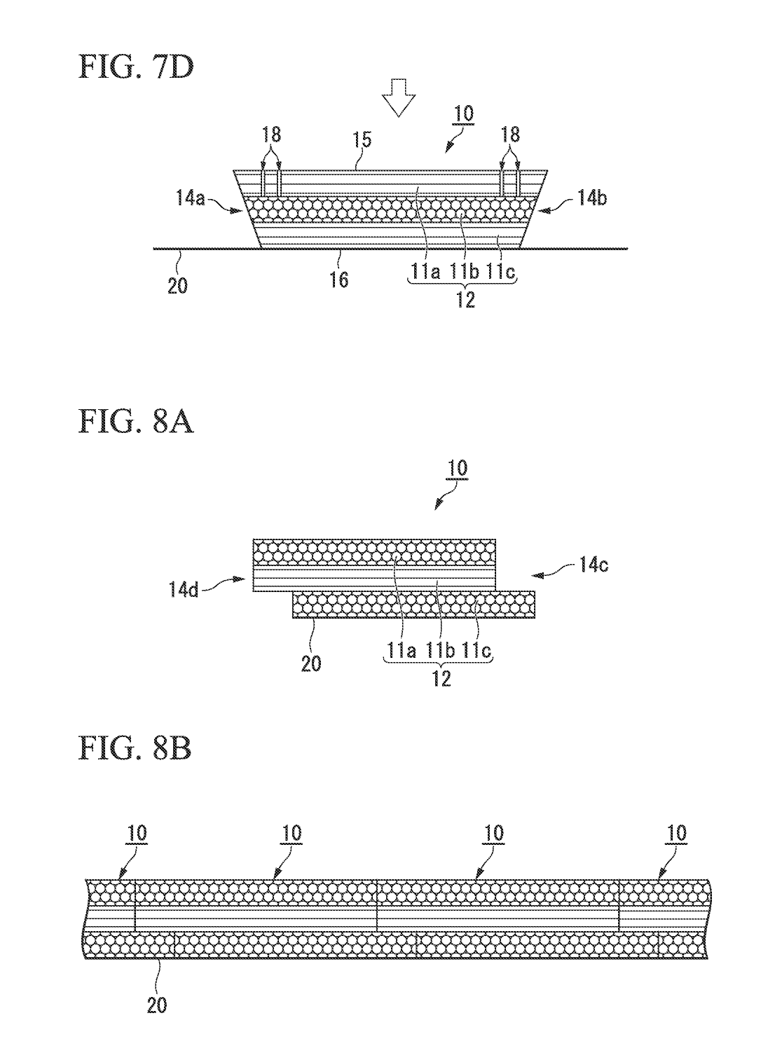

Next, as shown in FIG. 7A, the plate-like bodies are stacked to obtain a laminated body so that an orientation direction of the foams 13a of the first plate-like body 11a is nearly perpendicular to an orientation direction of the foams 13b of the second plate-like body 11b, and the orientation direction of the foams 13b of the second plate-like body 11b is nearly perpendicular to an orientation direction of the foams 13c of the third plate-like body 11c. The respective plate-like bodies are adhered to each other using an adhesive (for example, a vinyl acetate-based adhesive), a two-sided adhesive tape or the like, and are thus stacked. The adhesive may be applied to all over the surface of one plate-like body to which the other plate-like body is adhered (brought into contact with), or may be applied in dots or lines. The adhering sites of the two-sided adhesive tape are determined in the same manner as in the case of the adhesive application positions.

Next, the contact side surfaces 14a and 14b of the laminated body 12 are cut, so that the contact side surfaces 14a and 14b of the obtained laminated body 12 are inclined inward from the upper surface 15 of the laminated body 12 toward the bottom surface 16 (FIG. 7B). Similarly, the non-contact side surfaces 14c and 14d of the laminated body 12 are cut, so that the non-contact side surfaces 14c and 14d of the laminated body 12 are inclined in the same direction (FIG. 7C).

Furthermore, as shown in FIG. 7B, near the side surfaces 17 at both ends of the foams from among the side surfaces of the first plate-like body 11a, two grooves 18 are formed perpendicular to the orientation direction of the foams and along the side surfaces 17.

Next, as shown in FIG. 7D, the reinforcing sheet 20 extends in a direction parallel to the orientation direction of the foams of the first plate-like body 11a so as to be longer than the thickness of the heat insulation material 10, and is adhered to the bottom surface 16 of the laminated body 12 to obtain the heat insulation material 10.

The reinforcing sheet 20 is adhered to the bottom surface 16 of the laminated body 12 using an adhesive (for example, a vinyl acetate-based adhesive), a two-sided adhesive tape, a tucker or the like. The adhesive is preferably applied to the bottom surface 16 of the laminated body 12 in dots or lines. In some cases, the heat insulation material 10 is cut in accordance with the size of the frame body when being disposed in the frame body. When an adhesive is applied to all over the bottom surface 16 of the laminated body 12, the reinforcing sheet 20 is more strongly adhered to the bottom surface 16. That is, since the reinforcing sheet 20 is not easily peeled from the bottom surface 16, when the heat insulation material 10 is cut, the reinforcing sheet 20 is also cut. When the adhesive is applied to the bottom surface 16 in dots or lines, the reinforcing sheet 20 is more easily intentionally peeled from the bottom surface 16 than in the case of overall adhesion. Therefore, even when the heat insulation material 10 is cut, the reinforcing sheet 20 is not cut. However, the adhesive is preferably applied to at least four angle portions of the bottom surface 16, so that the reinforcing sheet 20 is not carelessly peeled from the bottom surface 16.

The adhering sites of the two-sided adhesive tape and the nailing positions of the tucker are determined in the same manner as in the case of the adhesive application positions.

Since the above-described heat insulation material 10 is formed of plate-like bodies including cellulose (used paper) and starch, it is sufficiently eco-friendly.

In addition, in the heat insulation material 10, the plate-like bodies neighboring in the lamination direction are stacked so that an orientation direction of foams of one plate-like body is nearly perpendicular to an orientation direction of foams of the other plate-like body. Accordingly, the heat insulation material 10 can exhibit excellent rigidity in any direction and is not easily bent. Therefore, the bending and sagging at the center of the heat insulation material when it is disposed in the frame body are reduced, the gap is not easily formed between the plywood base installed on the heat insulation material and the heat insulation material, and an excellent heat insulation property can be exhibited.

The heat insulation material of the invention is not limited to the above-mentioned heat insulation material 10.

For example, the number of the plate-like bodies of the laminated body is not limited to three, and may be two or four or more. However, the larger the number of the plate-like bodies, the more excellent the rigidity exhibited by the heat insulation material. However, when the number of the plate-like bodies increases, the thickness of the heat insulation material increases in accordance with the increase. When the thickness of the heat insulation material increases, the size (depth) of the frame body itself also varies in accordance with the thickness of the heat insulation material, and it is necessary to secure a space to accept the heat insulation material therein. Therefore, when the number of the plate-like bodies increases, the thickness of each plate-like body is preferably made smaller, so that the thickness of the entire heat insulation material does not increase.

In addition, the laminated body is not limited to the configuration in which the contact side surfaces are inclined inward from the upper surface of the laminated body toward the bottom surface, and the contact side surfaces may be inclined inward from the bottom surface toward the upper surface.

Furthermore, the laminated body is not limited to the configuration in which the non-contact side surfaces are inclined in the same direction. For example, as shown in FIG. 8A, any of the plate-like bodies 11 neighboring in the lamination direction may deviate in a direction in which the side surface (non-contact side surface) 14c which is not brought into contact with the frame body is connected to the side surface (non-contact side surface) 14d on the opposite side. Since any of the plate-like bodies 11 deviate in a direction in which the non-contact side surfaces 14c and 14d are connected to each other, when heat insulation materials 10 are arranged in a line in the longitudinal direction of the frame member, the neighboring heat insulation materials 10 form a ship-lap shape (when plates are joined to each other, the ends of both of them are cut off by half of the thickness and stuck to each other) as shown in FIG. 8B, whereby the heat insulation materials 10 can be arranged without a gap therebetween.

### Second Embodiment

The first embodiment has described the case in which the heat insulation material 10 is disposed in the frame body 100 formed of the frame members (lumber girders) 110 extending parallel to each other as shown in FIG. 1, but the invention is not limited thereto.

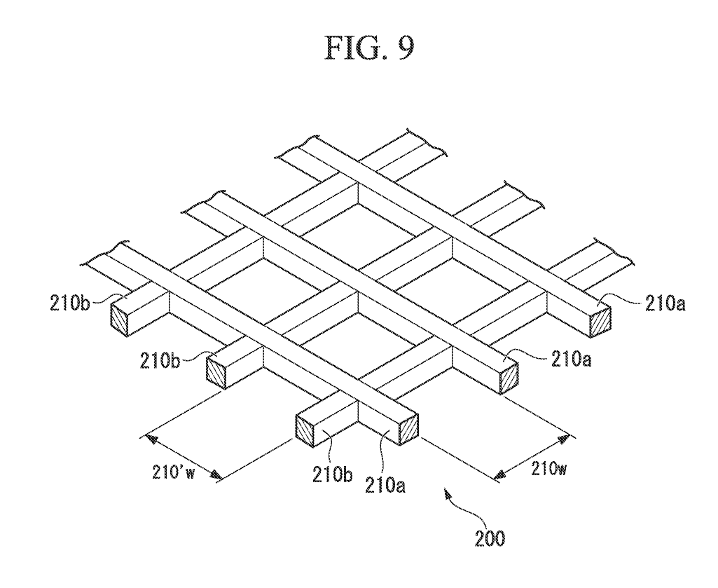

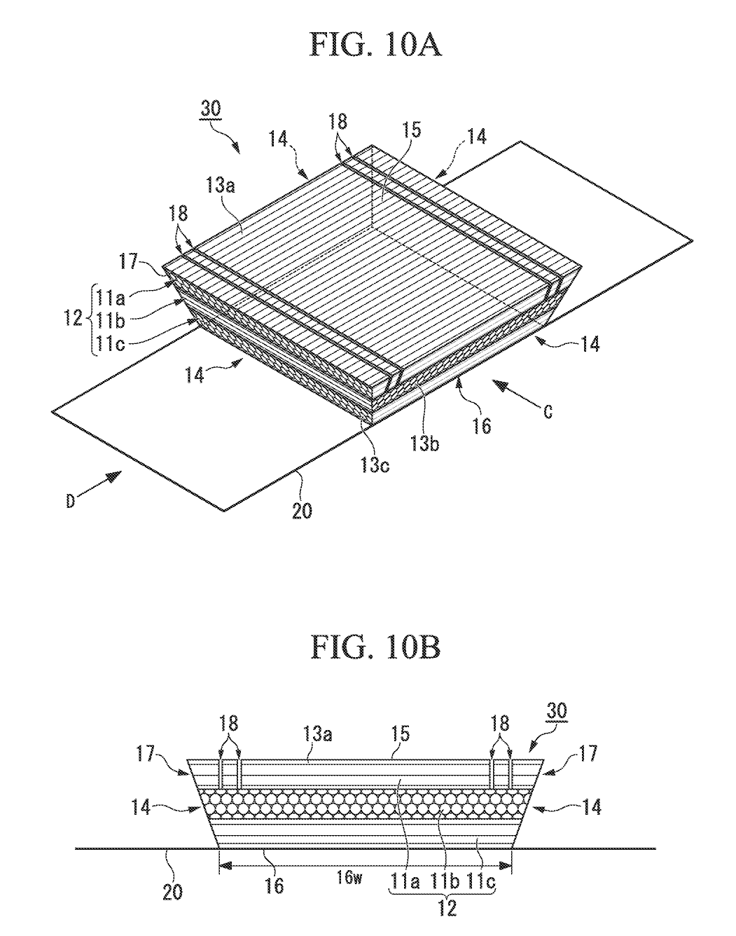

For example, when a heat insulation material is disposed in a grid-like frame body 200 formed of frame members 210a extending parallel to each other and frame members 210b extending parallel to each other to be bridged between the frame members 210a as shown in FIG. 9, all of the side surfaces of the laminated body of the heat insulation material are brought into contact with the frame body 200. Accordingly, as shown in FIG. 10A, in a heat insulation material 30, all of side surfaces 14 of a laminated body 12 are preferably inclined. The direction of the inclination is not particularly limited. However, in view of easy insertion into the frame body, the side surfaces 14 are preferably inclined inward from an upper surface 15 of the laminated body 12 toward a bottom surface 16 as shown in FIGS. 10B and 10C.

FIG. 10B is a side view when the heat insulation material 30 shown in FIG. 10A is viewed from C, and FIG. 10C is a side view when the heat insulation material 30 is viewed from D.

In addition, as in the heat insulation material 10 shown in FIG. 2, in the heat insulation material 30, near side surfaces 17 at both ends of foams 13a from among the side surfaces of a first plate-like body 11a including the upper surface 15, two grooves 18 perpendicular to an orientation direction of the foams 13a are formed along the side surfaces 17 at both ends.

In the heat insulation material 30, one width (width when the heat insulation material 30 of FIG. 10A is viewed from C) 16w and the other width (width when the heat insulation material 30 of FIG. 10A is viewed from D) 16′w of the bottom surface 16 of the laminated body 12 are slightly smaller than a distance 210w between the frame members 210a of the frame body 200 shown in FIG. 9 and a distance 210′w between the frame members 210b, and the side surfaces 14 are inclined inward from the upper surface 15 toward the bottom surface 16. In addition, since the upper surface 15 of the laminated body 12 is larger than the frame body, a portion protruding from the frame body is formed. However, the heat insulation material 30 has elasticity, whereby when the heat insulation material 30 is inserted into the frame body, the side surfaces 14 are pushed against the frame body and the protruding portion is pushed into the frame body. Accordingly, the heat insulation material 30 is disposed in the frame body without a gap therebetween.

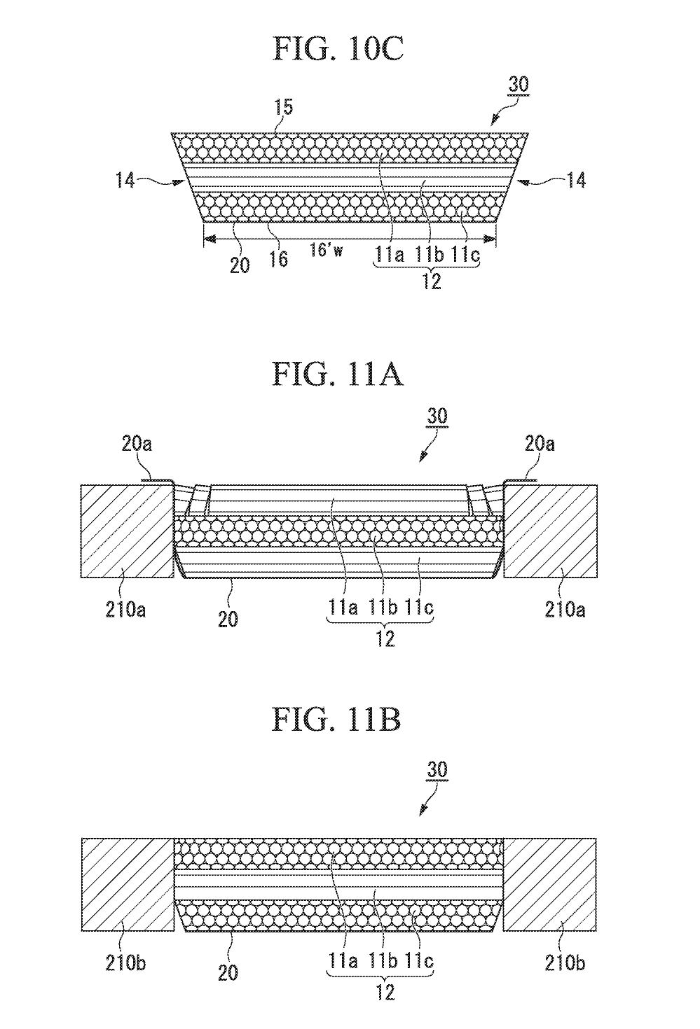

In the first plate-like body 11a, the grooves 18 are provided near the side surfaces (that is, side surfaces at both ends of the foams) perpendicular to the orientation direction of the foams as described above. Since the grooves 18 are formed, when the heat insulation material 30 is inserted into the grid-like frame body and is pushed against the frame members of the frame body, a first movable piece 19a and a second movable piece 19b are deformed as shown in FIG. 4B, whereby the heat insulation material 30 is easily pushed into the frame body. Here, FIG. 11A shows a state in which the heat insulation material 30 viewed from C of FIG. 10A is disposed in the frame body 200 shown in FIG. 9.

In addition, the remaining side surfaces (that is, side surfaces parallel to the orientation direction of the foams 13a) from among the side surfaces of the first plate-like body 11a are easily deformed elastically. Accordingly, when the heat insulation material 30 is inserted into the grid-like frame body and is pushed against the frame members of the frame body, the remaining side surfaces of the first plate-like body 11a are elastically deformed, and thus the heat insulation material 30 is easily pushed into the frame body. Accordingly, near the remaining side surfaces of the first plate-like body 11a, there is no need to form a groove along the side surfaces. Here, FIG. 11B shows a state in which the heat insulation material 30 viewed from D of FIG. 10A is disposed in the frame body 200 shown in FIG. 9.

### Third Embodiment

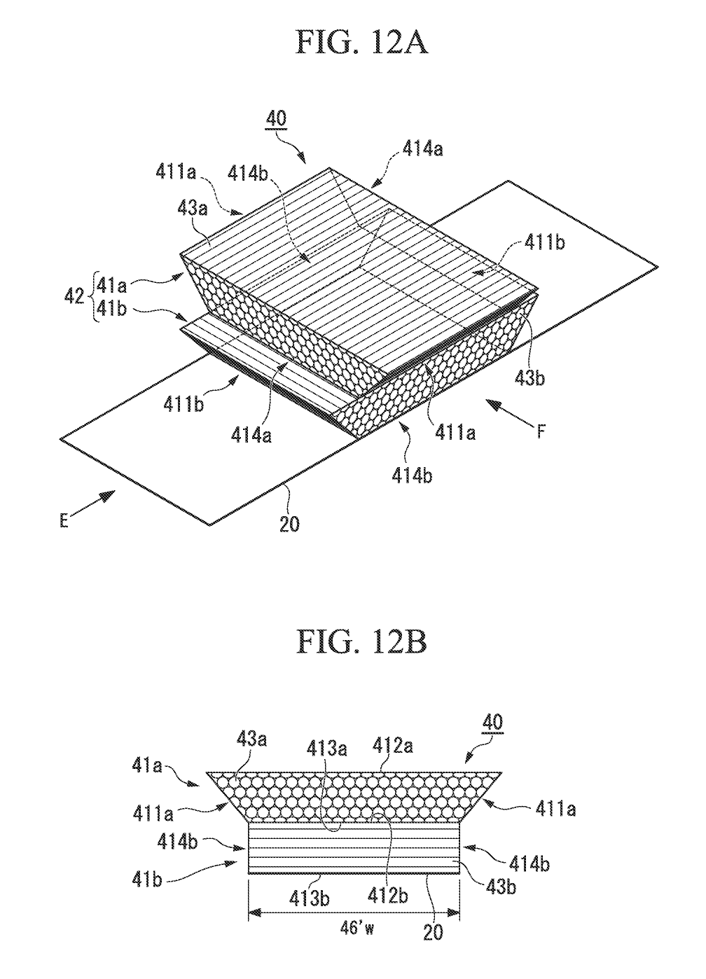

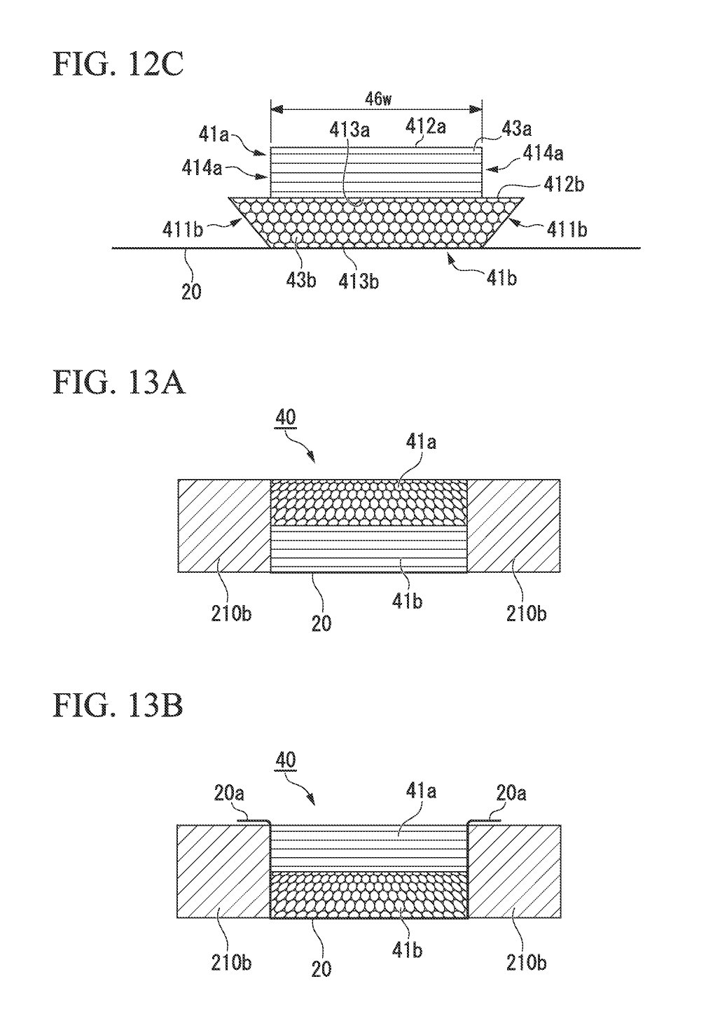

When a heat insulation material is disposed in the grid-like frame body 200 shown in FIG. 9, a heat insulation material 40 shown in FIGS. 12A and 12B may be used as the heat insulation material. Here, the heat insulation material 40 will be described in detail. FIG. 12A is a perspective view of the heat insulation material 40, FIG. 12B is a side view when the heat insulation material 40 shown in FIG. 12A is viewed from E, and FIG. 12C is a side view when the heat insulation material 40 shown in FIG. 12A is viewed from F.

The heat insulation material 40 shown in FIG. 12A is formed of a laminated body 42 in which a first plate-like body 41a and a second plate-like body 41b are stacked so that an orientation direction of foams of the first plate-like body 41a and an orientation direction of foams of the second plate-like body 41b are nearly perpendicular to each other.

As shown in FIGS. 12B and 12C, in the first plate-like body 41a, side surfaces 411a parallel to an orientation direction of foams 43a are inclined inward from an upper surface 412a of the first plate-like body 41a toward a bottom surface 413a. In addition, side surfaces 414a perpendicular to the orientation direction of the foams 43a are vertical to the upper surface 412a and the bottom surface 413a.

In the second plate-like body 41b, side surfaces 411b parallel to an orientation direction of foams 43b are inclined inward from an upper surface 412b of the second plate-like body 41b toward a bottom surface 413b. In addition, side surfaces 414b perpendicular to the orientation direction of the foams 43b are vertical to the upper surface 412b and the bottom surface 413b.

The side surfaces (inclined side surfaces) 411a of the first plate-like body 41a project outward more than the side surfaces (vertical side surfaces) 414b of the second plate-like body 41b, and the side surfaces (inclined side surfaces) 411b of the second plate-like body 41b project outward more than the side surfaces (vertical side surfaces) 414a of the first plate-like body 41a.

In the heat insulation material 40, widths (widths when the heat insulation material 40 of FIG. 12A is viewed from F) 46w of the upper surface 412a and the bottom surface 413a of the first plate-like body 41a are slightly smaller than the distance 210w between the frame members 210a of the frame body 200 shown in FIG. 9. Of the second plate-like body 41b, a portion projecting outward more than the vertical side surface 414a of the first plate-like body 41a protrudes from the frame body.

In addition, in the heat insulation material 40, widths (widths when the heat insulation material 40 of FIG. 12A is viewed from E) 46′w of the upper surface 412b and the bottom surface 413b of the second plate-like body 41b are slightly smaller than the distance 210′w between the frame members 210b of the frame body 200 shown in FIG. 9. Of the first plate-like body 41a, a portion projecting outward more than the vertical side surface 414b of the second plate-like body 41b protrudes from the frame body.

However, as described above, the plate-like body is low in rigidity with respect to a direction perpendicular to the orientation direction of the foams, that is, with respect to an external force from the side surfaces parallel to the orientation direction of the foams, and is thus elastically deformed.

When the heat insulation material 40 is inserted into the frame body, the projecting portion of the second plate-like body 41b is pushed in a direction perpendicular to the orientation direction of the foams 43b by the frame member. Meanwhile, the projecting portion of the first plate-like body 41a is pushed in a direction perpendicular to the orientation direction of the foams 43a by the frame member. As a result, the projecting portions of the plate-like bodies are elastically deformed and the heat insulation material 40 is pushed into the frame body and disposed with no gap therebetween.

Here, FIG. 13A shows a state in which the heat insulation material 40 viewed from E of FIG. 12A is disposed in the frame body 200 shown in FIG. 9, and FIG. 13B shows a state in which the heat insulation material 40 viewed from F of FIG. 12A is disposed in the frame body 200 shown in FIG. 9.

The heat insulation material 40 shown in FIGS. 12A to 12C can be manufactured, for example, as follows.

First, the first plate-like body 41a and the second plate-like body 41b are prepared.

Next, the side surfaces 411a parallel to the orientation direction of the foams 43a of the first plate-like body 41a are cut to be inclined inward from the upper surface 412a toward the bottom surface 413a. The same operation is also performed in the second plate-like body 41b.

Next, the plate-like bodies are stacked to obtain the laminated body 42 so that the orientation direction of the foams 43a of the first plate-like body 41a and the orientation direction of the foams 43b of the second plate-like body 41b are nearly perpendicular to each other. The plate-like bodies are stacked to be adhered to each other with an adhesive, a two-sided adhesive tape or the like.

Next, the reinforcing sheet 20 is adhered to the bottom surface 413b of the second plate-like body 41b in a state where the reinforcing sheet 20 extends in a direction parallel to the orientation direction of the foams 43a of the first plate-like body 41a so as to be longer than the thickness of the heat insulation material 40, thereby obtaining the heat insulation material 40. The reinforcing sheet 20 is adhered to the bottom surface 413b of the second plate-like body 41b using an adhesive, a two-sided adhesive tape, a tucker or the like.

### Fourth Embodiment

In the first to third embodiments, descriptions have been given on the assumption that a frame member is a lumber girder, but the invention is not limited thereto.

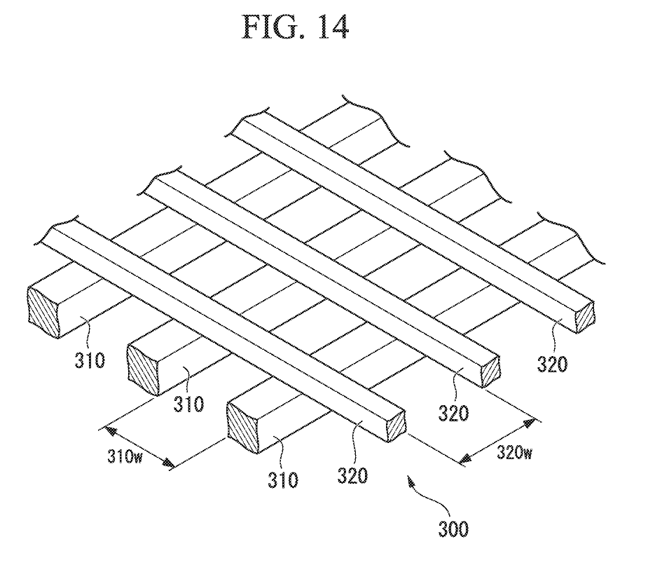

For example, as shown in FIG. 14, the heat insulation material may be disposed in a frame body 300 formed of lumber girders 310 extending parallel to each other and joists (crossbars supporting a floorboard) 320 attached on the lumber girders 310 and extending in a direction perpendicular to the lumber girders 310.

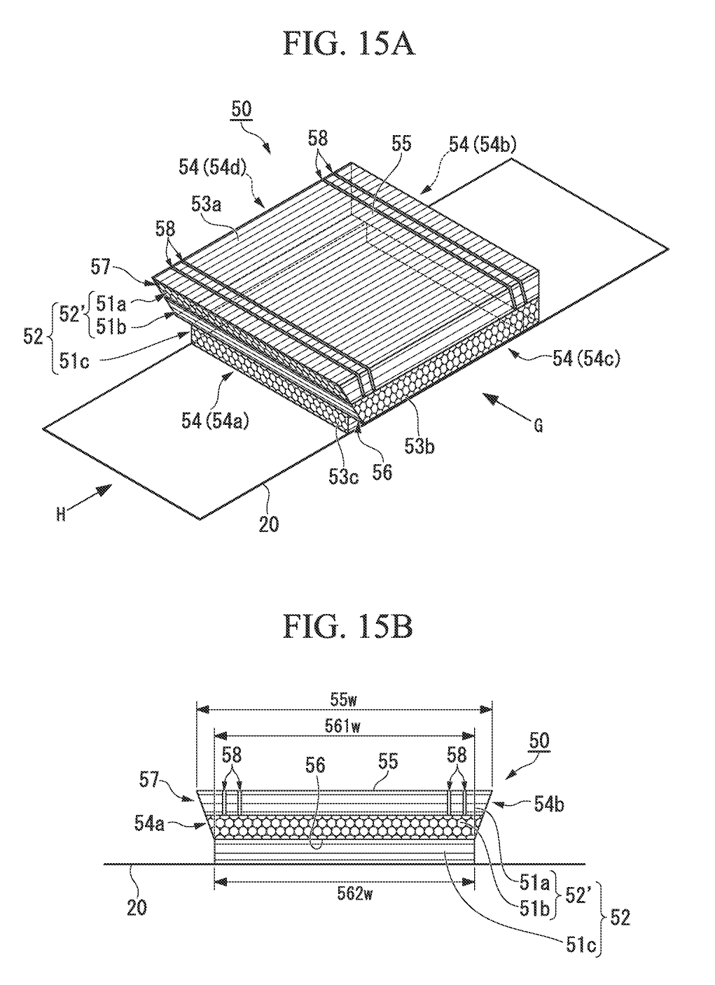

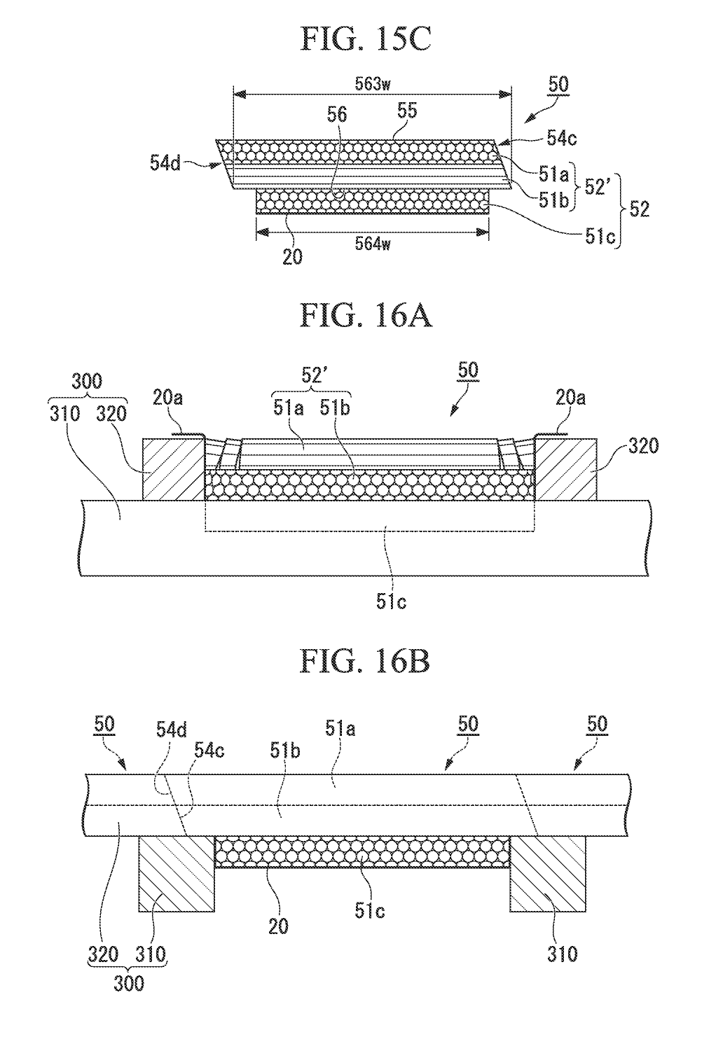

When a heat insulation material is disposed in such a frame body 300, the above-mentioned heat insulation material 10 (FIG. 2 and the like) may be used as the heat insulation material, but, for example, a heat insulation material 50 shown in FIGS. 15A to 15C may be used. Here, the heat insulation material 50 will be described in detail. FIG. 15A is a perspective view of the heat insulation material 50, FIG. 15B is a side view when the heat insulation material 50 shown in FIG. 15A is viewed from G, and FIG. 15C is a side view when the heat insulation material 50 shown in FIG. 15A is viewed from H.

The heat insulation material 50 includes a laminated body 52 in which a third plate-like body 51c is stacked on a laminated material 52′ formed of a first plate-like body 51a and a second plate-like body 51b.

In the laminated body 52, an orientation direction of foams 53a of the first plate-like body 51a and an orientation direction of foams 53b of the second plate-like body 51b are nearly perpendicular to each other, and the orientation direction of foams 53b of the second plate-like body 51b and an orientation direction of foams 53c of the third plate-like body 51c are nearly perpendicular to each other.

In the heat insulation material 50, the thickness of the laminated material 52′ and the thickness of the joist 320 of the frame body 300 shown in FIG. 14 are almost the same, and the thickness of the third plate-like body 31c and the thickness of the lumber girder 310 are almost the same.

In addition, the heat insulation materials 50 are arranged in a line in the longitudinal direction of the joist 320 while the laminated material 52′ is brought into contact with the joist 320.

In the heat insulation material 50, from among side surfaces 54 of the laminated material 52′, side surfaces which are brought into contact with the joists 320 are inclined inward from an upper surface 55 of the laminated material 52′ toward a bottom surface 56 opposed to the upper surface 55. In addition, a side surface which is not brought into contact with the joist 320 and a side surface on the opposite side are inclined in the same direction.

In the heat insulation material 50, from among the side surfaces 54 of the laminated material 52′, side surfaces 54a and 54b perpendicular to the orientation direction of the foams 53a of the first plate-like body 51a including the upper surface 55 of the laminated material 52′ are set as side surfaces which come into contact with the joist 320 (hereinafter, referred to as “contact side surfaces”), and side surfaces 54c and 54d parallel to the orientation direction of the foams 53a are set as side surfaces which do not come into contact with the joist 320 (hereinafter, referred to as “non-contact side surfaces”).

Furthermore, in the first plate-like body 51a, near side surfaces 57 at both ends of the foams 53a from among the side surfaces of the first plate-like body 51a, two grooves 58 perpendicular to the orientation direction of the foams 53a are formed along the side surfaces 57 at both ends.

In the heat insulation material 50, as shown in FIG. 15B, one width (width when the heat insulation material 50 of FIG. 15A is viewed from G) 561w of the bottom surface 56 of the laminated material 52′ and a length 562w of the foams 53c of the third plate-like body 51c are the same.

In addition, one width 561w of the bottom surface 56 of the laminated material 52′ and the length 562w of the foams 53c of the third plate-like body 51c are slightly smaller than a distance 320w between the joists 320 of the frame body 300 shown in FIG. 14. Meanwhile, a width (width when the heat insulation material 50 of FIG. 15A is viewed from G) 55w of the upper surface 55 of the laminated material 52′ is larger than the distance 320w between the joists 320, and in the laminated material 52′, a portion protruding between the joists 320 is formed. However, since the grooves 58 are provided in the first plate-like body 51a, a first movable piece 19a and a second movable piece 19b are deformed as shown in FIG. 4B when the first plate-like body 51a is pushed against the joists 320. In addition, the second plate-like body 51b is easily deformed elastically when being pushed against the joists 320. Accordingly, as shown in FIG. 16A, the heat insulation material 50 is disposed between the joists 320 without a gap therebetween.

As shown in FIG. 15C, the other width (width when the heat insulation material 50 of FIG. 15A is viewed from H) 563w of the bottom surface 56 of the laminated material 52′ is longer than a width (width when the heat insulation material 50 of FIG. 15A is viewed from H) 564w of the third plate-like body 51c, and the laminated material 52′ projects from the third plate-like body 51c.

In addition, the width 564w of the third plate-like body 51c is slightly smaller than a distance 310w between the lumber girders 310 of the frame body 300 shown in FIG. 14.

When the heat insulation material 50 is inserted into the frame body 300, the heat insulation material 50 is disposed in the frame body 300 so that the third plate-like body 51c is fit between the lumber girders 310 as shown in FIG. 16B.

In the heat insulation material 50, the non-contact side surfaces 54c and 54d of the laminated material 52′ are inclined in the same direction. Accordingly, when the heat insulation materials 50 are arranged in a line in the longitudinal direction of the joist 320, the neighboring heat insulation materials 50 support each other while pushing each other not only in the arrangement direction (horizontal direction) but also in the vertical direction, and thus the heat insulation materials 50 can be disposed with no gap therebetween.

The heat insulation material 50 shown in FIGS. 15A to 15C can be manufactured, for example, as follows.

First, the first plate-like body 51a, the second plate-like body 51b, and the third plate-like body 51c are prepared so that these have a predetermined size.

The plate-like bodies 51a and 51b are stacked to obtain the laminated material 52′ so that the orientation direction of the foams 53a of the first plate-like body 51a and the orientation direction of the foams 53b of the second plate-like body 51b are nearly perpendicular to each other. The plate-like bodies are stacked to be adhered to each other with an adhesive, a two-sided adhesive tape or the like.

The contact side surfaces 54a and 54b of the obtained laminated material 52′ are cut to be inclined inward from the upper surface 55 of the laminated material 52′ toward the bottom surface 56. Similarly, the non-contact side surfaces 54c and 54d of the laminated material 52′ are cut to be inclined in the same direction.

Furthermore, near the side surfaces 57 at both ends of the foams from among the side surfaces of the first plate-like body 51a, two grooves 58 are formed perpendicular to the orientation direction of the foams and along the side surfaces 57.

Using an adhesive, a two-sided adhesive tape or the like, the third plate-like body 51c is adhered to the bottom surface 56 of the laminated material 52′ so that the orientation direction of the foams 53b of the second plate-like body 51b and the orientation direction of the foams 53c of the third plate-like body 51c are nearly perpendicular to each other.

A reinforcing sheet 20 is adhered to the bottom surface of the second plate-like body 51b in a state where the reinforcing sheet 20 extends in a direction parallel to the orientation direction of the foams 53a of the first plate-like body 51a so as to be longer than the thickness of the heat insulation material 50, thereby obtaining the heat insulation material 50. The reinforcing sheet 20 is adhered to the bottom surface of the third plate-like body 51b using an adhesive, a two-sided adhesive tape, a tucker or the like.

In the above-described heat insulation material of the invention, since the plate-like bodies neighboring in the lamination direction are stacked so that the orientation direction of the foams of one plate-like body and the orientation direction of the foams of the other plate-like body are nearly perpendicular to each other, the heat insulation material can exhibit excellent rigidity in any direction and is not easily bent. Therefore, the bending and sagging at the center of the heat insulation material when it is disposed in the frame body are reduced, the gap is not easily formed between the plywood base installed on the heat insulation material and the heat insulation material, and an excellent heat insulation property can be exhibited.

The heat insulation material of the invention is not limited to a heat insulation material for a floor structure, and is preferably used as a heat insulation material for a wall or a ceiling.

When the heat insulation material of the invention is used for a wall, the heat insulation material is disposed between columns, between a column and a stud, and the like. In addition, when the heat insulation material is used for a ceiling, the heat insulation material is disposed between rafters.

### EXAMPLES

Hereinafter, the invention will be described in detail with reference to examples. However, the invention is not limited thereto.

### Example 1

### Preparation of Plate-Like Body

A foam material was prepared by mixing 45 parts by mass of a polypropylene resin, 35 parts by mass of cellulose, and 20 parts by mass of starch

The obtained foam material was foamed while being extruded from a die having a plurality of pores to obtain an assembly in which a plurality of rod-like foams according to the number of the pores were oriented in one direction, and brought into close contact with each other with no gap therebetween to be formed integrally with each other. In the foaming, water was used as a foaming agent.

The obtained assembly was formed into a plate shape (size: 820 mm×820 mm×30 mm) to prepare a plate-like body.

### Manufacturing of Heat Insulation Material

The obtained three plate-like bodies were adhered to each other using a vinyl acetate-based adhesive to prepare a laminated body (size: 820 mm×820 mm×90 mm, weight: 1,400 g), and the laminated body was used as a heat insulation material.

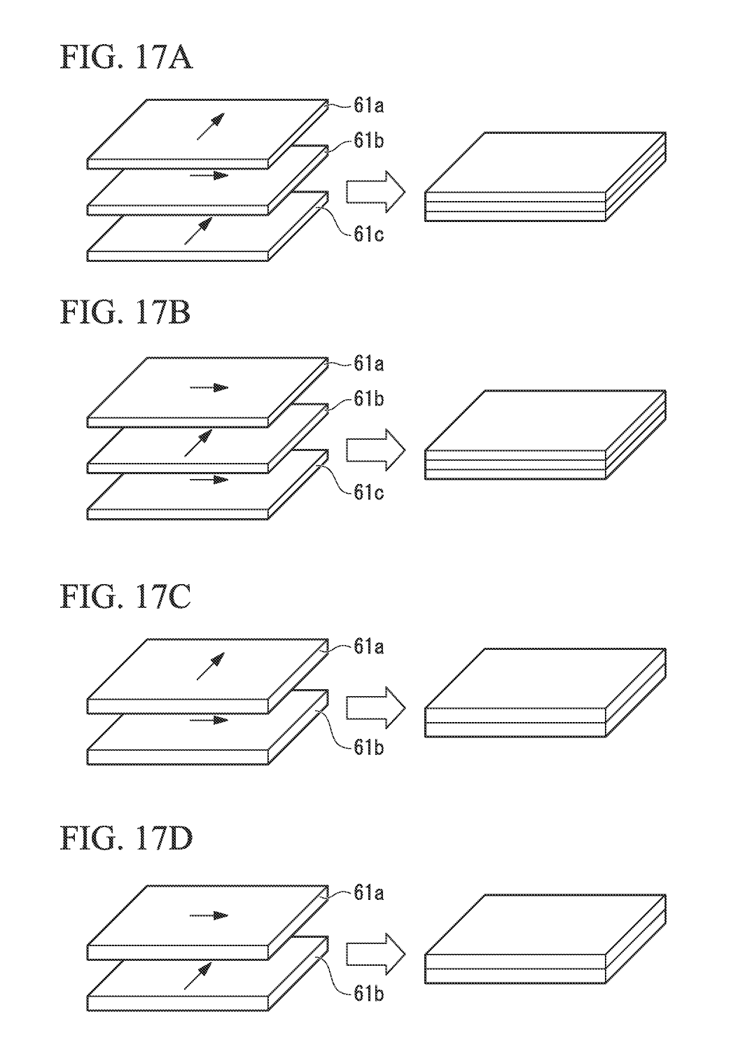

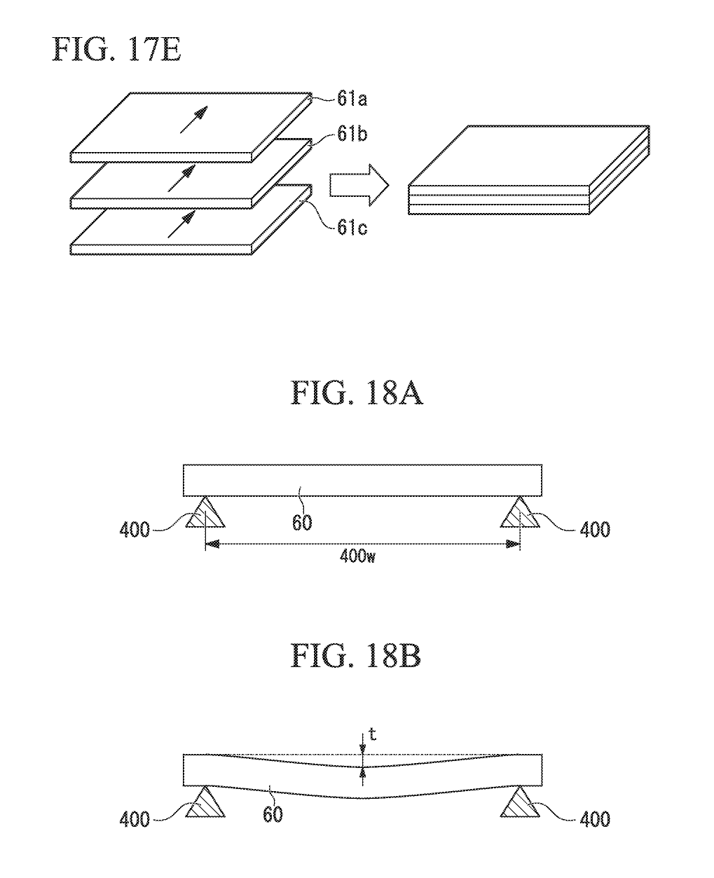

In the adhering of the three plate-like bodies, as shown in FIG. 17A, the plate-like bodies are stacked so that the orientation direction of the foams of a first plate-like body 61a and the orientation direction of the foams of a second plate-like body 61b are perpendicular to each other, and the orientation direction of the foams of the second plate-like body 61b and the orientation direction of the foams of a third plate-like body 61c are perpendicular to each other. The orientation directions of the foams of the plate-like bodies are shown by the arrows in the drawings.

### Measurement of Bending Amount

Using the obtained heat insulation material, a bending amount was measured as follows.

As shown in FIG. 18A, a heat insulation material 60 was put on supporting members 400 (distance 400w between the supporting members 400: 800 mm) extending parallel to each other to support the heat insulation material 60. The direction of the heat insulation material 60 was set so that the orientation direction of the foams of the first plate-like body 61a and the extending direction of the supporting member 400 were parallel to each other.

In addition, as shown in FIG. 18B, the bending amount when the heat insulation material 60 was bent due to its weight (sagging depth t (mm) of the most sagging portion) was measured. The results are shown in Table 1.

The orientation directions of the foams of the plate-like bodies of the heat insulation material are shown in Table 1. In Table 1, “parallel” means a direction parallel to the extending direction of the supporting member 400, and “perpendicular” means a direction perpendicular to the extending direction of the supporting member 400.

### Example 2

A heat insulation material was manufactured in the same manner as in Example 1, except that the orientation directions of the foams of the three plate-like bodies were changed as shown in Table 1 and FIG. 17B, and a bending amount was measured. The results are shown in Table 1.

### Examples 3 and 4

Plate-like bodies were prepared in the same manner as in Example 1, except that the thickness was changed to 45 mm.

Using the obtained two plate-like bodies, a heat insulation material was manufactured in the same manner as in Example 1, except that the orientation directions of the foams of the plate-like bodies were changed as shown in Table 1 and FIGS. 17C and 17D, and a bending amount was measured. The results are shown in Table 1.

### Comparative Example 1

A heat insulation material was manufactured in the same manner as in Example 1, except that the orientation directions of the foams of three plate-like bodies were changed as shown in Table 1 and FIG. 17E, and a bending amount was measured. The results are shown in

TABLE 1

| | | | | | Comparative |
|---|---|---|---|---|---|
| | Example 1 | Example 2 | Example 3 | Example 4 | Example 1 |
| First | Parallel | Perpen- | Parallel | Perpen- | Parallel |
| Plate-like | | dicular | | dicular | |
| Body | | | | | |
| Second | Perpen- | Parallel | Perpen- | Parallel | Parallel |
| Plate-like | dicular | | dicular | | |
| Body | | | | | |
| Third | Parallel | Perpen- | — | — | Parallel |
| Plate-like | | dicular | | | |
| Body | | | | | |
| Bending | 5 | 0 | 6 | 0 | 10 |
| Amount | | | | | |
| (mm) | | | | | |

As is obvious from Table 1, it was possible to suppress the heat insulation materials obtained in the respective examples from being bent due to the weight of the heat insulation materials.

Particularly, the bending amounts of the heat insulation materials of Examples 2 and 4, in which the plate-like bodies were stacked so that the orientation direction of the foams of the first plate-like body 61a was perpendicular to the extending direction of the supporting member 400, were 0 mm, and it was possible to more effectively suppress the bending.

In addition, when Example 1 is compared to Example 3, Example 1 in which the number of the plate-like bodies was larger implies the fact that the bending could be further suppressed in comparison to Example 3.

In the heat insulation material of Comparative Example 1 in which the three plate-like bodies were stacked so that the orientation directions of the foams of the plate-like bodies were the same, the bending amount was large, that is, 10 mm, and the bending due to its own weight occurred.

### INDUSTRIAL APPLICABILITY

In a heat insulation material of the invention, plate-like bodies neighboring in the lamination direction are stacked so that an orientation direction of foams of one plate-like body and an orientation direction of foams of the other plate-like body are nearly perpendicular to each other. Accordingly, the heat insulation material can exhibit excellent rigidity in any direction and is not easily bent. Therefore, the bending and sagging at the center of the heat insulation material when it is disposed in the frame body are reduced, a gap is not easily formed between the plywood base installed on the heat insulation material and the heat insulation material, and an excellent heat insulation property can be exhibited.

### REFERENCE SIGNS LIST

10, 30, 40, 50, 60: HEAT INSULATION MATERIAL

11: PLATE-LIKE BODY

11a, 41a, 51a: FIRST PLATE-LIKE BODY

11b, 41b, 51b: SECOND PLATE-LIKE BODY

11c, 51c: THIRD PLATE-LIKE BODY

12, 42, 52: LAMINATED BODY

52′: LAMINATED MATERIAL

13, 13a, 13b, 13c, 43a, 43b, 53a, 53b, 53c: FOAM

14, 54: SIDE SURFACE

14a, 14b, 54a, 54b: SIDE SURFACE (CONTACT SIDE SURFACE)

14c, 14d, 54c, 54d: SIDE SURFACE (NON-CONTACT SIDE SURFACE)

411a, 411b: SIDE SURFACE (INCLINED SIDE SURFACE)

414a, 414b: SIDE SURFACE (VERTICAL SIDE SURFACE)

15, 412a, 412b, 55: UPPER SURFACE

16, 413a, 413b, 56: BOTTOM SURFACE

17, 57: SIDE SURFACE OF FIRST PLATE-LIKE BODY

18, 58: GROOVE

20: REINFORCING SHEET

100, 200, 300: FRAME BODY

110, 210, 310: FRAME MEMBER (LUMBER GIRDER)

320: JOIST

1. A heat insulation material comprising:
a laminated body in which a plurality of plate-like bodies are stacked,
wherein in each of the plate-like bodies, a plurality of rod-like foams, obtained by extrusion-foaming a foam material, are oriented in one direction to be formed integrally with each other, and
wherein the plate-like bodies neighboring in the lamination direction are stacked so that an orientation direction of the foams of one plate-like body and an orientation direction of the foams of the other plate-like body are nearly perpendicular to each other.

2. The heat insulation material according to claim 1, which is disposed in a frame body.

3. The heat insulation material according to claim 2,
wherein from among side surfaces of the laminated body, side surfaces which are brought into contact with the frame body are inclined.

4. The heat insulation material according to claim 3,
wherein the side surfaces which are brought into contact with the frame body are inclined inward from an upper surface or a bottom surface of the laminated body toward the bottom surface or the upper surface opposed thereto, and at least one of the side surfaces which are brought into contact with the frame body is a surface perpendicular to the orientation direction of the foams of the plate-like body including one of the upper surface and the bottom surface of the laminated body wider than the other, and
wherein in the plate-like body including the wider surface, near side surfaces at both ends of the foams of the plate-like body, a groove perpendicular to the orientation direction of the foams is formed along the side surfaces at both ends.

5. The heat insulation material according to claim 2,
wherein the frame body is formed of frame members extending parallel to each other, and
wherein from among the side surfaces of the laminated body, a side surface which is not brought into contact with the frame body and a side surface on the opposite side are inclined in the same direction.

6. The heat insulation material according to claim 2,
wherein the frame body is formed of frame members extending parallel to each other, and
wherein any of the plate-like bodies neighboring in the lamination direction deviate in a direction in which a side surface which is not brought into contact with the frame body is connected to a side surface on the opposite side.

7. The heat insulation material according to claim 2,
wherein the frame body has a grid shape, and in the plate-like bodies, a side surface parallel to the orientation direction of the foams is inclined.

8. The heat insulation material according to claim 1,
wherein a moisture-permeable reinforcing sheet is adhered to a bottom surface of the laminated body so that the reinforcing sheet extends to be longer than the thickness of the heat insulation material in a direction parallel to the orientation direction of the foams of the plate-like body including a upper surface opposed to the bottom surface,

9. The heat insulation material according to claim 1,
wherein the foam material includes a polyolefin resin, cellulose, and starch.
